(19) United States
(12) Patent Application Publication
(10) Pub. No.: US 2017/0243216 A1
(43) Pub. Date: Aug. 24, 2017

(54) DIGITAL PAYMENT PROCESSING UTILIZING ENCRYPTED COMPUTER NETWORKING

(71) Applicant: BRADLEY ELLIOTT KOHN, WEST HOLLYWOOD, CA (US)

(72) Inventor: BRADLEY ELLIOTT KOHN, WEST HOLLYWOOD, CA (US)

(21) Appl. No.: 15/418,509

(22) Filed: Jan. 27, 2017

Related U.S. Application Data
(60) Provisional application No. 62/288,376, filed on Jan. 28, 2016.

(51) Int. Cl. G06Q 20/40; G06Q 20/12; G06Q 20/38

(52) U.S. Cl. CPC G06Q 20/401; G06Q 20/3829; G06Q 20/1235

(57) ABSTRACT

This disclosure includes, among other things, teachings of a variety of improved techniques including payment systems that utilize Encrypted Computer Networking (ECN) to provide industrial transparency, rapid accounting and payment, end-to-end credibility inspiring user confidence and assurance for the monetization, payment processing, and royalty distribution of copyrights, content, services and agreements. Components of the disclosed payment system run on ECN, such as the Blockchain, as a backend to process payments.

Teachings relate to computer-implemented payment systems that utilize encrypted computer networking. Teachings more particularly relate to computer-implemented methods, systems, and an apparatus for the monetization, digital payment processing, and royalty distribution of and for copyrights and content, services, and agreements via encrypted computer networking.

### BACKGROUND

Currently, there is still not a transparent, streamlined, and potentially uniform way of monetizing digital content. Part of the reason for this is that the current mainstream financial systems are unable to cost-effectively process micro-payments due to relatively high transaction fees. As such, conventional payment systems for digital content include a landscape of subscription models across music, print media, TV and film industries that collect upfront monthly, annual, or subdivisions of annual payments as revenue generation; part of which is paid in the form of royalties and payments to upstream parties such as content creators, publishers, and copyright owners. These payment systems are cumbersome, slow, at times corrupt or at least non-transparent, and differ in how they value the same pieces of content. Furthermore, they are proving to devalue content, and are undesirably being offered as a “better than piracy” model. Accordingly, a need exists to overcome the drawbacks of existing payment systems.

### BRIEF DESCRIPTION OF THE DRAWINGS

FIG. 1 is a block diagram of a payment system that utilizes encrypted computer networking according to some embodiments of the present disclosure;

FIG. 2 is a block diagram of a payment service provider that utilizes encrypted computer networking according to some embodiments of the present disclosure;

FIG. 3 is a flow diagram of the payment system that utilizes encrypted computer networking according to some embodiments of the present disclosure;

FIG. 4 illustrates a “Quick Click” process for a single use license obtained through a content sharing portal (e.g., YouTube) according to some embodiments of the present disclosure;

FIG. 5 illustrates options displayed by hovering a mouse pointer for a predetermined period (e.g., 1 second or more) over the video display window of the content sharing portal (e.g., YouTube) according to some embodiments of the present disclosure;

FIG. 6 illustrates a process for playing content by selecting a “Play” option to issue a single use license according to some embodiments of the present disclosure;

FIG. 7 illustrates a process for purchasing content by selecting a “Purchase” option according to some embodiments of the present disclosure;

FIG. 8 illustrates a process for renting content by selecting a “Rent” option to display various rent sub-options according to some embodiments of the present disclosure;

FIG. 9 illustrates a process for sharing content by selecting a “Share” option according to some embodiments of the present disclosure;

FIG. 10 illustrates a process for how users can tip without purchasing a license for content by selecting a “Tip” option according to some embodiments of the present disclosure; and

FIG. 11 illustrates a user login screen administered by the payment service provider of the payment system according to some embodiments of the present disclosure.

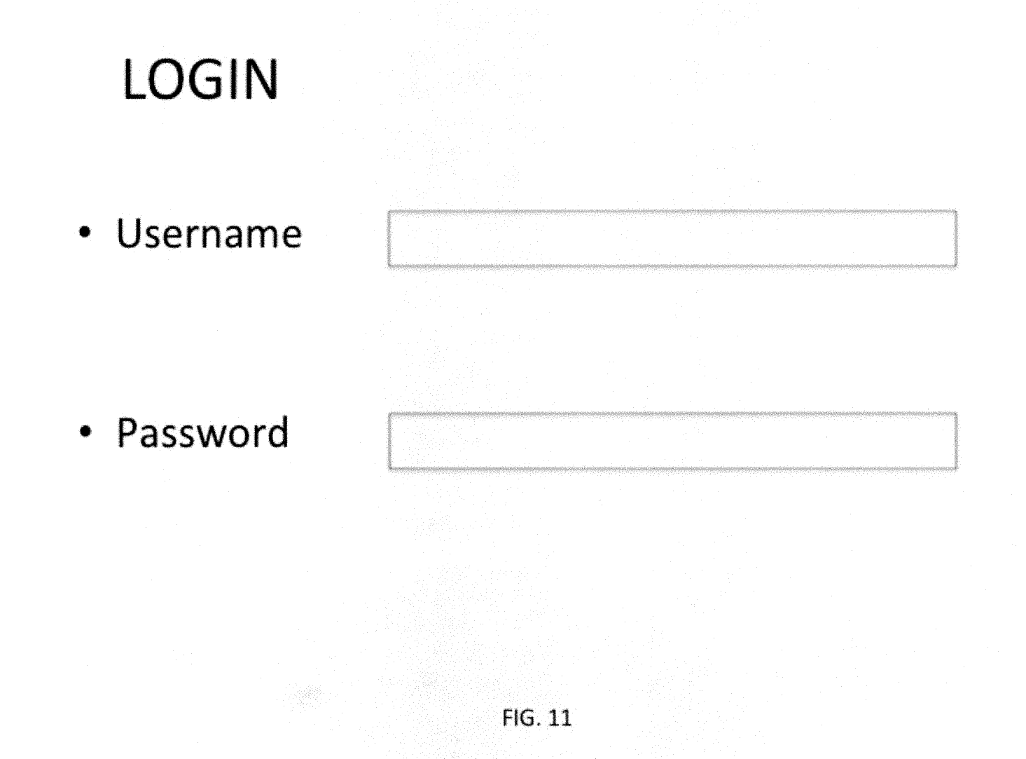

### DETAILED DESCRIPTION

Embodiments described herein relate to a computer-implemented payment service provider of a payment system that utilizes Encrypted Computer Networking (ECN) for the monetization, digital payment processing, and royalty distribution of and for copyrights and content, services, and agreements. In particular, embodiments include a framework (e.g., the payment service provider) that is integrated with a public ledger and cryptocurrency system (i.e., the ECN) in order to facilitate a complex payment structure between consumers and content providers. For example, the ECN may be the Blockchain, which operates as a public ledger of transactional data records for bitcoin (i.e., a cryptocurrency). As such, the payment service provider can utilize the Blockchain to facilitate complex payment processing for content. It is understood by one of ordinary skill in the art that Bitcoin is interchangeable with other cryptocurrencies that are available for use.

Content may include any combination of text, images, video, audio, software, or other digital data that could be rendered on a computing device. More specifically, but not exclusively, content may include musical works (e.g., both in recorded or print form), print media (e.g., documents, reports, photos, and visual art), 3D Works (e.g., schematics), printing instructions and manuals, holographic works, TV shows and infomercials (however distributed, e.g., networks, internet sites, blogs, YouTube, Vimeo, Peer-to-Peer (P2P), or other content portal providers), video media (e.g., films, documentaries, short films, advertisements, music videos, “Behind The Scenes” footage, and trailers), encrypted or non-encrypted data for sale, lease, or for hire, and any other copyrights, products, and services now known or yet to be invented.

The disclosed embodiments overcome the drawbacks of existing payment systems such as subscription models that are failing content creators and fragmenting the digital landscape. For example, platforms such as Spotify, Pandora, Apple Music, Netflix, Hulu, HBO, The Washington Post, The New York Times, YouTube, Vimeo, and various other platforms that provide portals to content, currently monetize content in different ways and at different amounts. It usually takes excessive periods of time for revenue payments to reach content creators and copyright owners and, furthermore, there is a lack of transparency in existing payment systems as to how much revenue is actually generated and how it is distributed to upstream parties (e.g., content creators and copyright owners). These and other drawbacks of existing systems are detailed in US Patent Publication Nos. US 2011/0099096 A1 and US 2008/0071561 A1, which refer to databases or Database Service Providers (DSPs) for data, as a way by which to calculate royalty payments.

Embodiments of the disclosed payment system work in a completely new way that is not only a new technology but a completely new paradigm in how copyrights are distributed, monetized, and represented in that it is decentralized, transparent, available to all, provides record keeping, and is safe, fast, and accurate. As such, this addresses all of the abovementioned issues with existing payment systems by streamlining, automatizing, and objectifying the current model by use of proprietary technology and ECNs such as the Blockchain. Moreover, the disclosed embodiments can be utilized for the processing and handling of large, small, and micro payments for goods and services both online and offline.

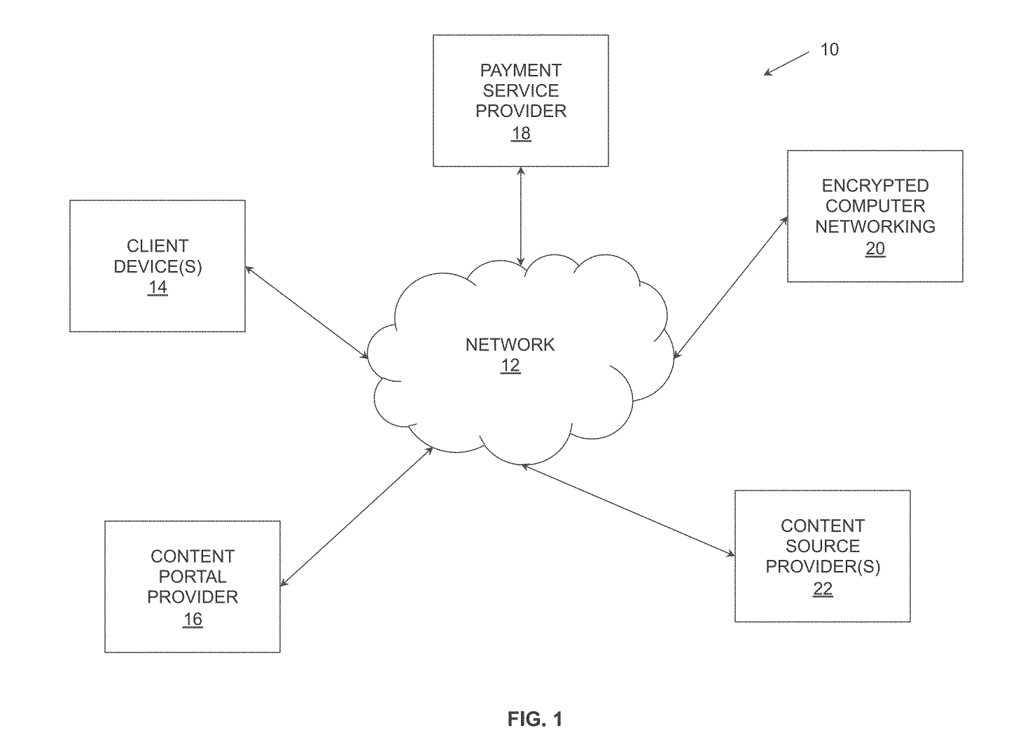

FIG. 1 is a block diagram of a payment system that utilizes ECN according to some embodiments of the present disclosure. As shown, the payment system 10 includes one or more components interconnected over a network 12 such as the Internet. The components shown include one or more client devices 14, a content portal provider 16, a payment service provider 18, ECN 20, and one or more content source providers 22. The network 12 may include any combination of private, public, wired, or wireless connections. Each component of the payment system 10 may include combinations of hardware and/or software to process data, perform functions, communicate over the network 12, and the like. For example, any component of the payment system 10 may include a processor, memory or storage, a network transceiver, a display, operating system and application software (e.g., for providing a user interface), and the like. Other components, hardware, and/or software included in the payment system 10 that are well-known to persons skilled in the art are not shown or discussed herein for brevity.

The client devices 14 are used by users in order to interact with the payment system 10. Examples of client devices include smart phones (e.g., Apple iPhone, Samsung Galaxy, Nokia Lumina), tablet computers (e.g., Apple iPad, Samsung Note, Amazon Fire, Microsoft Surface), computers (e.g., Apple MacBook, Lenovo 440), and any other device that is capable of rendering content obtained through a portal (e.g., website) provided by the content portal provider 16 over the network 12.

The content portal provider 16 may include any number of server computers that operate to provide a portal for accessing a library of content. Examples of a portal include a website or channels for providing the content to the client devices 14. As such, the client devices 14 can access content through the content portal provider 16. In some embodiments, users may establish individual accounts with the content portal provider 16 to access and organize content.

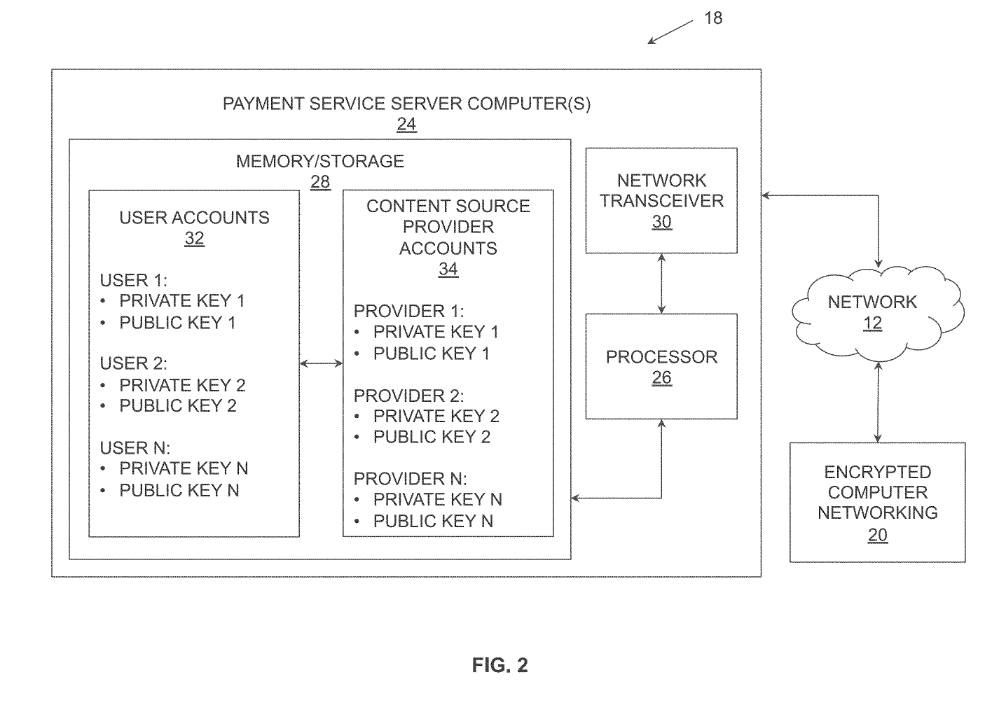

FIG. 2 is a block diagram of the payment service provider that utilizes ECN according to some embodiments of the present disclosure. The payment service provider 18 may include any number of server computers 24 that operate to establish and manage accounts for users and providers of content. As shown, the payment service server computers 24 include a processor 26, memory/storage 28, and a network transceiver 30. The memory/storage 28 stores user accounts 32 and content source provider accounts 34.

The payment service provider 18 utilizes public-key cryptography to securely process payments over network 12. Public-key cryptography uses asymmetric key algorithms, where a key used by one party to perform either encryption or decryption is not the same as the key used by another in the counterpart operation. Each party has a pair of cryptographic keys—a public encryption key and a private decryption key. For example, a key pair used for digital signatures consists of a private signing key and a public verification key. The public key may be widely distributed, while the private key is known only to its proprietor. The keys are related mathematically, but the parameters are chosen so that calculating the private key from the public key is unfeasible. Moreover, the keys could be expressed in various formats, including hexadecimal format.

As shown, each account includes a pair of private and public keys comprised in a digital wallet used to transact payments in any cryptocurrency by utilizing the ECN. An amount of cryptocurrency is available by the ECN through use of the key pair, but no balance is inherently kept anywhere in particular by the ECN; rather, there are transaction records which may be combined to determine a balance. The payments are from client devices 14 to content source providers 22 for rights to content provided through the content portal provider 16. In some embodiments, the payment service provider 18 may link its user accounts 32 to respective accounts of the content portal provider 16 in order seamlessly transact payments for content.

The payment service provider 18 transmits private and public keys to the ECN 20 via the network transceiver 30 to make payments to the content source providers 22 in accordance with rights purchased for the content accessed by the client devices 14 through the content portal provider 16. The ECN 20 may include a combination of computing devices connected over network 12. The ECN 20 provides a distributed database that operates as a public ledger of any cryptocurrency to maintain a continuously growing list of transactional data records. As is well-known in the art, transactions using an ECN are secure, reliable, and can occur in real-time for any amount of payment and in any currency. Specific applications of ECN including the Blockchain (e.g., the public ledger of transactions for bitcoin) that could be utilized by the payment service provider 18 are well-known to persons skilled in the art and, as such, are omitted from this disclosure for brevity.

Lastly, the content source providers 22 may include any combination of devices or services used by various sources of content (e.g., content creators, copyright owners, distributors) to distribute and manage their content, rights to that content, and payments for the rights to that content. Content source providers 22 (e.g., content creators) can host, sell, and distribute their content through various means and any number of platforms, whether serviced by the payment service provider 18 or not.

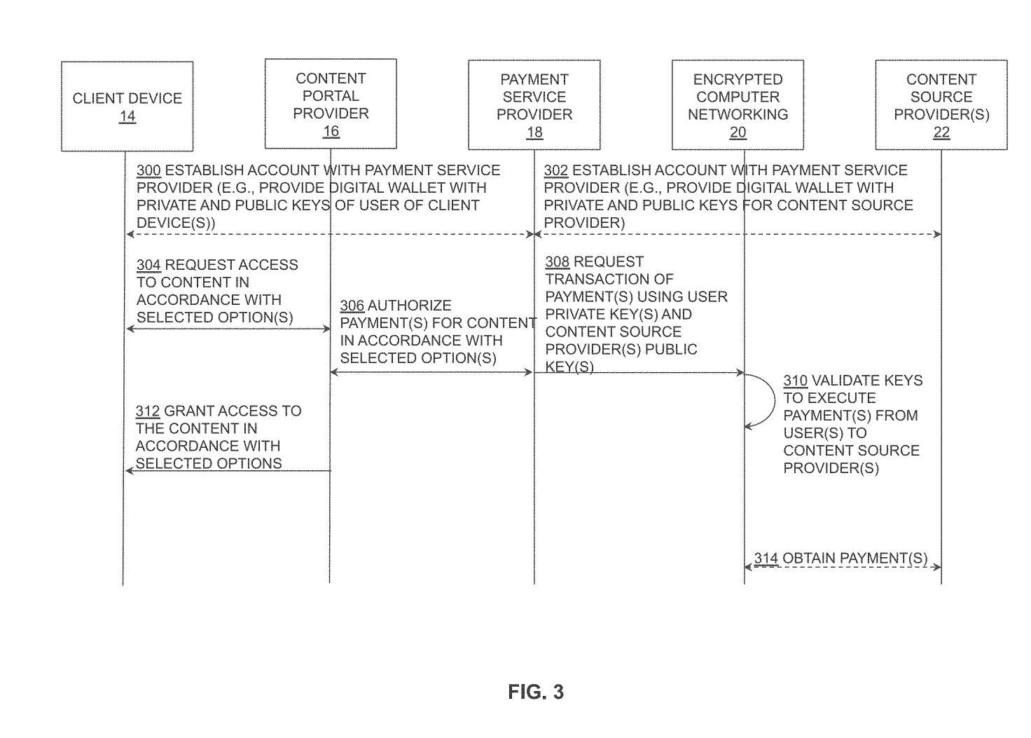

FIG. 3 is a flow diagram of the payment system that utilizes ECN 20 according to some embodiments of the present disclosure. As shown, in step 300, a user of a client device 14 may optionally register an account with the payment service provider 18 to allow for processing payments for that user. In step 302, the content source providers 22 (e.g., content creators, copyright owners, distributors) may also optionally register respective accounts with the payment service provider 18.

As indicated above, each of the accounts may include a digital wallet that includes a private key to authorize a payment on behalf of the account holder and includes a public key for receiving payment for an account holder. An account may be established with the payment service provider 18 at any time to transact payments for content provided through the content portal provider 16. Moreover, corresponding user accounts for the payment service provider 18 and content portal provider 16 may be functionally linked to expedite the transaction of payments for content for the user.

In some embodiments, the payment service provider 18 may utilize third-party services (e.g., PayPal) for processing payments. As such, the user of the client device 14 can utilize some services of the payment service provider 18 without registering an account for processing payments.

In step 304, the client device 14 sends a request to the content portal provider 16 to access content. For example, the content may be accessible by the client device 14 from a website or app (i.e., portals) administered by the content portal provider 16. In some embodiments, a portal administered by the content portal provider 16 may provide one or more options to obtain different licenses (i.e., types of rights) to content in exchange for different amounts of payment. As detailed below, examples of options include a license to view, purchase, rent, or share content. The content portal provider 16 may also provide an option to tip a content source provider 22 irrespective of any payment for a license to content.

In step 306, the content portal provider 16 requests, from the payment service provider 18, payment in exchange for rights to content in accordance with the selected options. In step 308, the payment service provider 18 sends a request to the ECN 20 including at least one private key for the user and one or more public keys for the content source providers 22. In step 310, the ECN 20 validates the keys received from the payment service provided 18 to complete payment from the user to the content source providers 22. More specifically, the ECN 20 utilizes the private key to authorize payment from the user, and utilizes the public keys to identify the recipients of the payment (i.e., the content source providers 22).

In step 312, upon receiving authorization by the payment service provider 18, the content portal provider 16 grants access to the content by the client device 14 in accordance with the selected options. Although step 312 is shown to occur after the payment transaction is completed at the ECN 20, the disclosure is not limited to this embodiment. Instead, for example, the content portal provider 16 may grant access to content after receiving authorization from the payment service provider 18 but before completing the payment transaction. Lastly, in step 314, the content source providers 22 can optionally obtain the payments from the ECN by, for example, using cryptocurrency exchanges.

The disclosed embodiments contemplate a variety of methods and systems for monetizing copyrights and content. As suggested above, the payment service provider 18 may utilize ECN 20 such as the Blockchain as a backend to process payments. As is well-known to persons skilled in the art, the Blockchain is a system built on integrity and ensures that transaction fees are never disproportionate to the transaction amount by utilizing its own network nodes if necessary to ensure the integrity of the transactions.

In some embodiments, pre-existing business agreements and revenue shares or splits between upstream parties (i.e., upstream source providers 22) may be written into the code of a copyright or its digital representation (i.e., content). At the point of sale of rights to the content, these agreements may be honored automatically by the payment service provider 18, and the results (e.g., payments) are distributed to each party's digital wallet via ECN 20. As such, a number of sub-payments are made at the time of the transaction to the relevant owners and rights holders of the copyright and its content.

More specifically, the payment service provider 18 may operate to embed metadata directly into content to facilitate making payments for rights to the content in accordance with predetermined arrangements specified by the metadata. The payment service provider 18 does so by, for example, having the relevant metadata embedded in code of a file comprising the content itself or, for non-digital products or services, having various transactional agreements registered in code at the point of transaction for the non-digital products or services. As such, at the point of transaction (e.g., whether sale, hire, stream or view (i.e., single use), tip, or share), the proceeds generated by the transaction can be automatically divided into appropriate and pre-agreed subdivisions designated by the metadata and sent to the relevant parties (i.e., content source providers 22). In some embodiments, some or all of these transactions may be subject to a fee (e.g., 5% fee) by the payment service provider 18 for embedding, handling, and upkeep of the metadata. All accounting by the payment service provider 18 can therefore be automatic, transparent, cannot be manipulated, and is viewable to all interested parties as a permanent record.

The disclosed systems and methods are applicable for use to monetize any product or service that integrates the payment service provider 18's technology in its payment processing system and, for example, will allow parties (e.g., manufacturers) to readily bypass or update their agreements with retailers, distributors, sales agents and marketers, whereby each party's specific remuneration could be written directly into the code of the product or service.

In some embodiments, the payment service provider 18 could operate as a platform much like Apple TV, iTunes, or Spotify to manage content in addition to managing complex payment processes for that content. The disclosed proprietary technology, however, is not so limited and could instead be licensed and utilized by any existing digital platforms (e.g. Facebook, Spotify, iTunes) as an add-on service, or can be made available to offline merchants as a custom app, at the point of commercial engagement with consumers.

The payment service provider 18 can also manage complex payment processes for content administered as radio style services such as Beats Radio, Pandora Radio, KCRW, IHeartRadio, and the like. For example, fees to the consumer will differentiate from on-demand content because broadcasters of radio style services will in essence subsidize the consumer experience because they do not pay for the content. As such, different payment structures are likely to be utilized according to whether content (e.g., music) is specifically selected on-demand by a user or curated according to the user's taste and administered by the radio platform that the user is using. This is particularly beneficial to users that use content as background media, e.g., music or TV playing in the background constantly.

FIGS. 3 through 10 illustrate basic functions of the payment service provider 18 via the user interface of YouTube according to some embodiments of the present disclosure. As shown, the payment service provider 18 can be designed to be used as part of a payment system for any and all financial transactions. Because of its unique ability to divide payments of any size into multiple complex fractions and then administer these multiple payments almost instantly and in any currency, it is an advantageous option available for transactions involving copyrights (i.e., right with multiple owners or recipients of payments such as royalties), service agreements, and complex commercial transactions. Content providers and/or distributors like Amazon, Spotify, Apple, Hulu, The New York Times, Rdio, among many others, all stand to benefit from the disclosed technology. Ultimately the disclosed technology will save users money by consolidating their spending with usage and increase profits to content creators via transparency, immediacy, and efficiency.

FIG. 3 illustrates a “Quick Click” process for a single use license in operation through a content sharing portal (e.g., YouTube) according to some embodiments of the present disclosure. As shown, as soon as a consumer clicks the play symbol displayed for a piece of content, the user is charged the appropriate single use license fee (i.e., the fee amount to view the content on the video screen). The various payments and/or royalties for the single use license are administered by the payment service provider 18 in accordance with pre-existing agreements to upstream content source providers 22 such as a copyright owner (i.e., record label), publisher, other writers, an artist, an artist manager, etc. The payment transactions can be completed almost instantaneously via the Blockchain (e.g., ECN 20).

In some embodiments, the current advertising model (or an adjustment thereof) utilized by content sharing portals such as YouTube may still be implemented at a user's discretion, subject to any agreements. For example, the user may optionally select to utilize the Blockchain for payment to bypass conventional advertising.

In some embodiments, the payment service provider 18 may operate in conjunction with the content portal provider 16 to administer advertisements. For example, the payment service provider 18 may affect what advertisements are displayed by content portal provider 16, and may administer allocation of payments from advertising revenue. In some embodiments, the content source providers 22 may affect what advertisements are displayed by the content portal provider 16. For example, the content source providers 22 (e.g., content creators) may control advertisements placed on or around their content and share in any related advertisement revenue.

As detailed above, payments for content are administered by the payment service provider 18 by utilizing the ECN 20. Specifically, the user accounts provisioned by the payment service provider 18 link users to their digital wallets to make payments while keeping user data encrypted and safe at all times. In some embodiments, a “User Settings” area is available once a user logs-in to a portal (e.g., website) administered by the payment service provider 18. This allows the user to customize the user's experience when obtaining rights to content provided by content portal providers 16 (e.g., YouTube). These settings may apply across any websites and platforms (i.e., portals) that utilize the payment service provider 18 to monetize content.

How each content portal provider decides to implement the technology may vary. As such, the payment service provider 18 may include a Content Management System (CMS) that provides platforms, websites, and vendors utilizing the payment service provider 18 the ability to customize how users (e.g., consumers) experience the payment service provider 18. For example, Apple may not want to offer a single use license on their Apple TV platform but instead keep their current rent or purchase model. Given the varying bespoke deals made when licensing movies and TV shows, there may well be a desire to vary the options offered depending on the content and its owners. All of these potentialities are facilitated with the backend (i.e., CMS) of the payment service provider 18.

In some embodiments, all the processing of the metadata for content monetization is performed by the payment service provider 18. As such, for example, content owners will be required to register the various components, parties, and interests of their content with the payment service provider 18 and ensure that they are legally compliant to sell and license these products. Once all metadata has been collected and verified, the payment service provider 18 may write it into the code of the product or service and make it available for sale and license using the disclosed technology.

At the point of commerce (i.e., time of transaction), the consumer may be given options depending on the product or service to buy, rent, view or stream (i.e., single use license), share (i.e., meaning either to gift or distribute), and/or tip specific parties (e.g., content creators). This allows consumers to have greater control over multiple complex payments to different upstream parties associated with rights to particular content, which is a main benefit to consumers provided by the disclosed payment service provider 18 of the payment system 10.

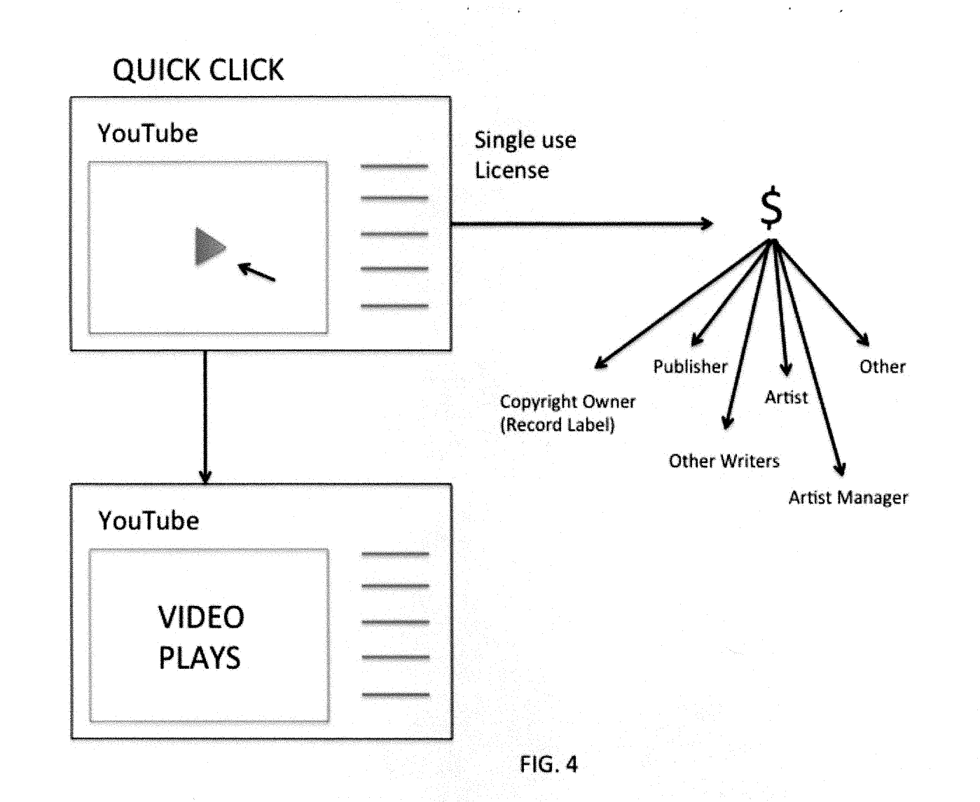

FIG. 4 illustrates options displayed by hovering the mouse pointer for a predetermined period (e.g., 1 second or more) over the video display window of a content sharing portal (e.g., YouTube) according to some embodiments of the present disclosure. This list of options includes the single use license (i.e., “Play”) as well as other “engagement options” such as “Purchase,” “Rent,” and “Share.” In some embodiments, the payment amounts for the “Play,” “Purchase,” and “Rent” options are displayed by clicking on one of these options. Also shown is a “Tip” mechanism option, which is a great way for users and fans to tip and communicate with content creators. Unlike the other transactions to view, purchase, or rent, content, a tip payment goes only to the content creators, not the copyright owners or distributors.

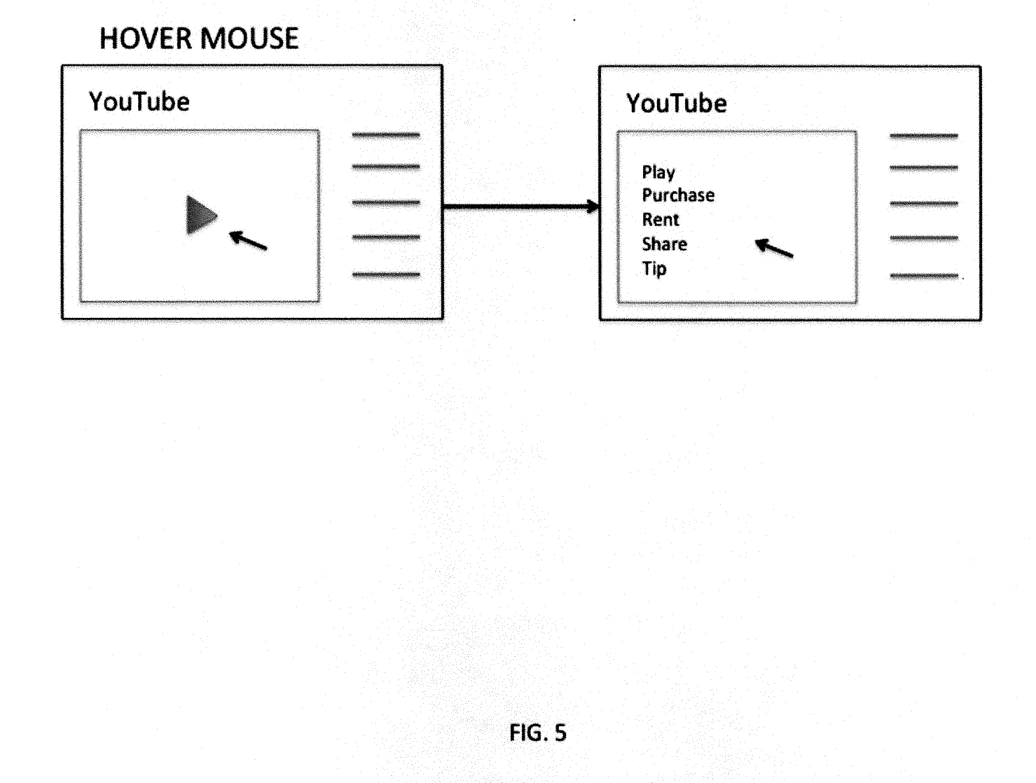

FIG. 5 illustrates a process for playing content by selecting the “Play” option to issue a single use license according to some embodiments of the present disclosure. The effect of selecting the “Play” option is similar to the “Quick Click” process. As shown, however, the “Play” option provides the opportunity to tip various parties and the price charged (“$x.xxxxx”) for the single use license is displayed. Again, all tips go directly to the content creators (e.g., musicians, artists, writers, directors, producers), and not the content owners (e.g., copyright owner, publisher, other writers, artist, artist manager). Tipping can be skipped by leaving the Tip field blank, and proceed straight to play. Users can also go back to select another option (e.g., purchase, rent, or share) if they change their minds.

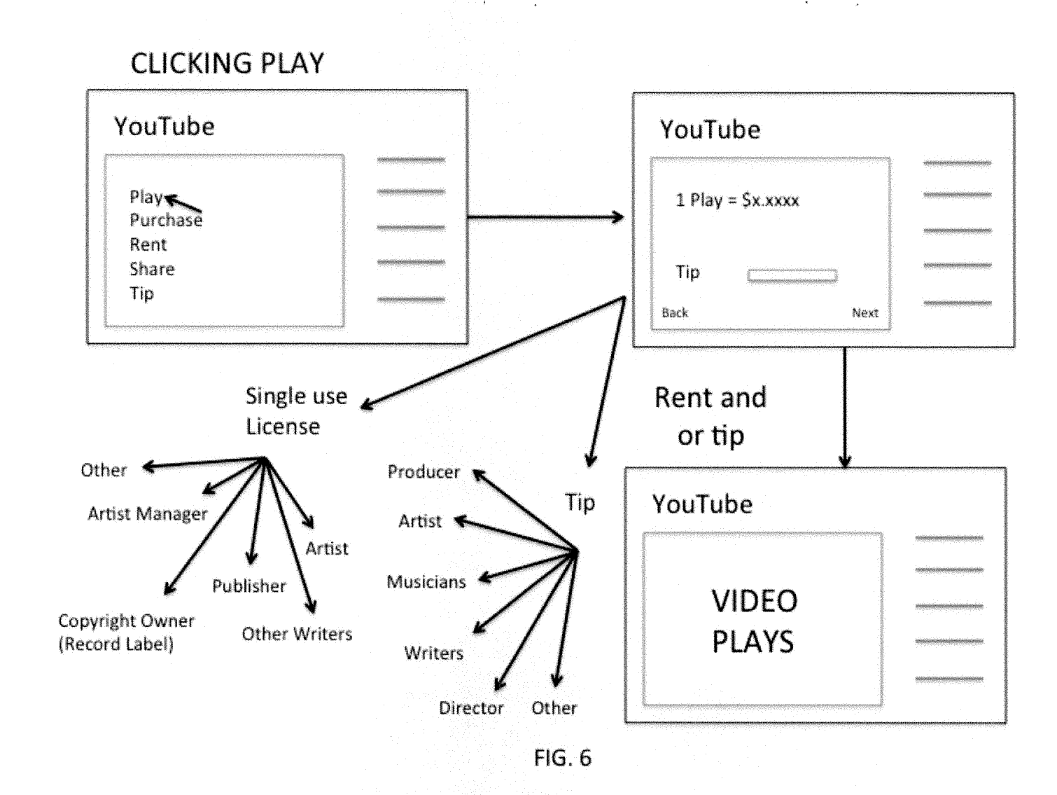

FIG. 6 illustrates a process for purchasing content by selecting the “Purchase” option according to some embodiments of the present disclosure. On doing so, the user's digital wallet is credited with a purchase license. The user can now view the purchased content from any device they login on. As shown, the user is presented fee information and provided the option to tip. As such, the process for distributing payments is similar to that when selecting the “Play” option. Moreover, the user is also given the option to download the content, and can do so at any time in the future by finding the content online and going to a purchase tab which will read “download” (as long as the user is logged in) or by viewing their licenses in an account manager user interface and selecting download. In some embodiments, users who have purchased a piece of content have play and rent privileges included in the purchase.

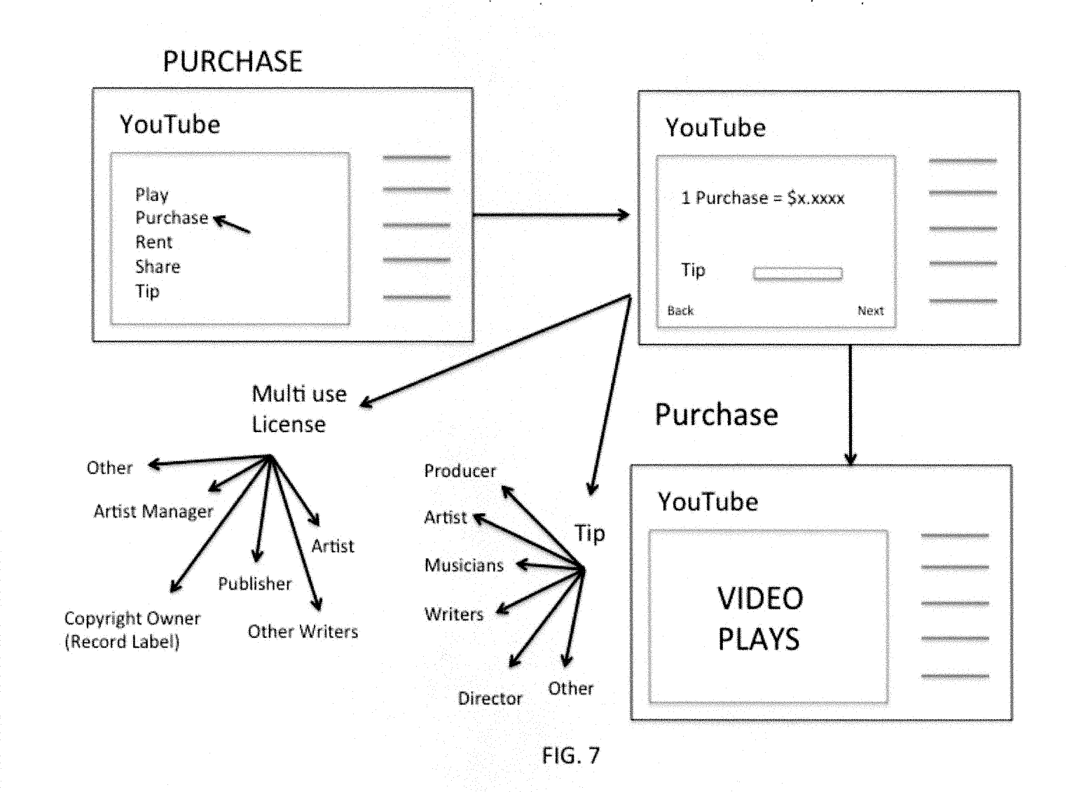

FIG. 7 illustrates a process for renting content by selecting the “Rent” option to display various rent sub-options. In this example, the user can rent a piece of content for a rent period of 1 day, 1 week, or 1 month by selecting respective sub-options. The prices may vary for each option. During the selected rent period, the user may have purchase privileges. Any downloaded content will be removed or password/license protected after the rental period expires. As shown, the user is presented with a tip option and, as such, the process for distributing payments is similar to that when selecting the “Play” option.

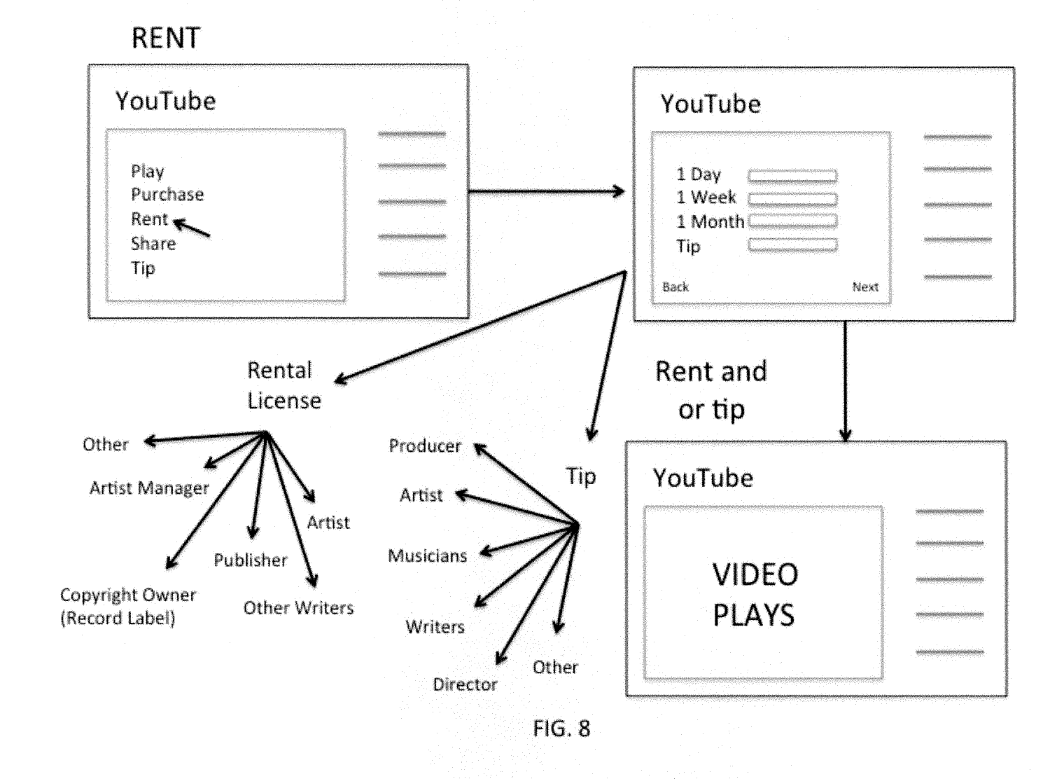

FIG. 8 illustrates a process for sharing content by selecting the “Share” option according to some embodiments of the present disclosure. Options for sharing content include “Link,” “Website,” “Blog,” and “Other” (e.g., email). The user is also presented with a tip option and, as such, the process for distributing payments is similar to that when selecting the “Play” option. When sharing content, however, a user is provided with options to cover the license fee(s) for selected user(s) that the user chooses for sharing the content.

As shown, the user may select one of the sharing options and its respective check-box to subsidize sharing. For example, if the user shares content on a social media website (e.g., Facebook) and checks the corresponding checkbox, an extra pop-up box will inform the user of the potentially higher costs associated with paying for multiple single use licenses and give the user the option to cap the amount of licenses they subsidize by number of licenses or total monetary value (e.g., displayed as “#______/$______”). On the other hand, the user does not subsidize viewing the content if the box is unchecked. In some embodiments, the default option when sharing a link or embedded content will be that new users cover their own license fees (e.g., the checkbox is unchecked).

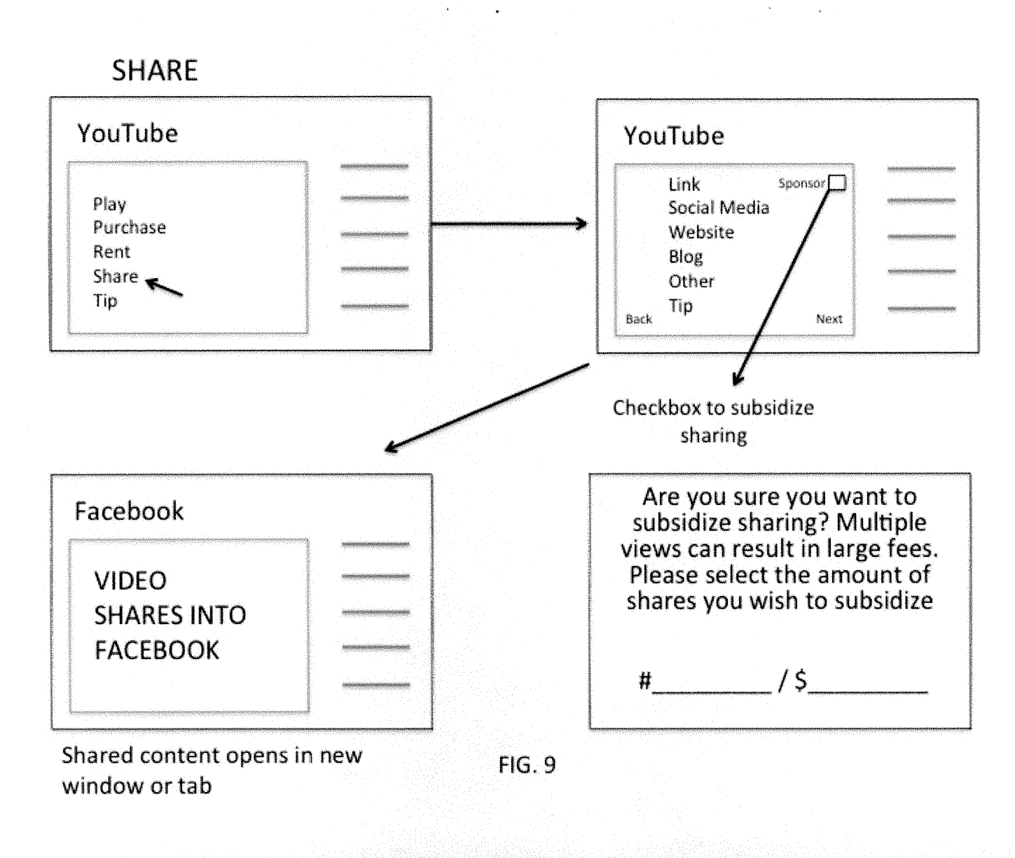

FIG. 9 illustrates a process for how users can tip without purchasing a license by selecting the “Tip” option according to some embodiments of the present disclosure. As shown, selecting the “Tip” options displays a Tip field box and an Message field box. A user may enter a tip amount and optionally input a message. The tip payment and message are then provided to various content source providers such as producers, musicians, the artist, writers, director, etc.

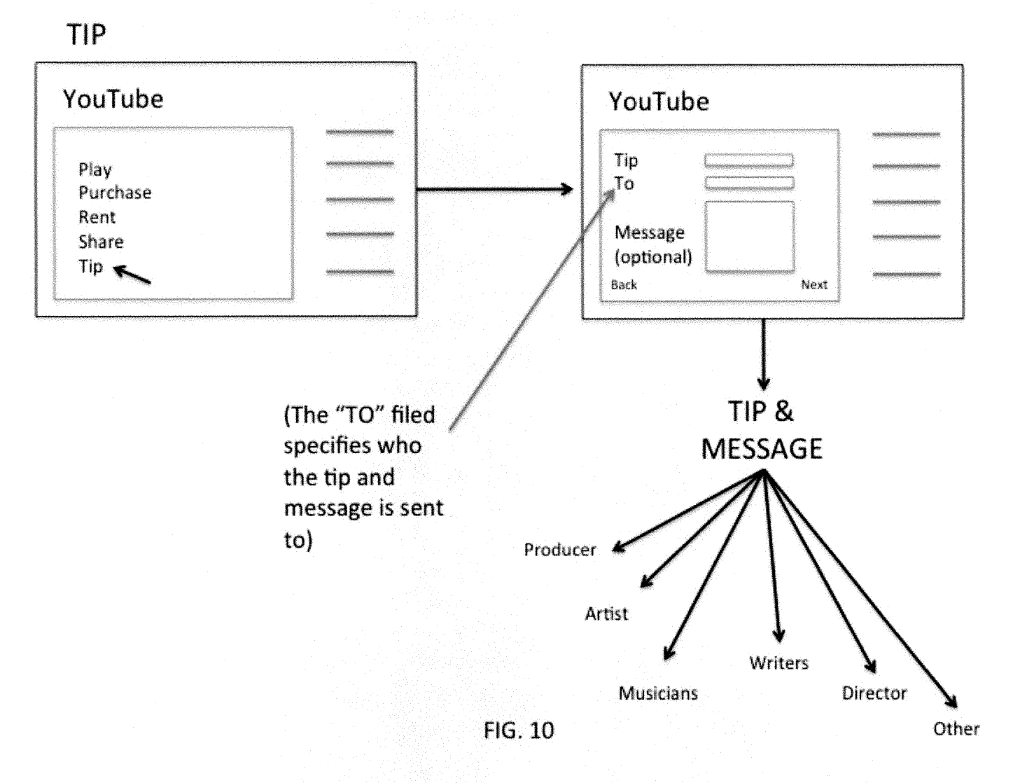

FIG. 10 illustrates the user login screen administered by the payment service provider 18 according to some embodiments of the present disclosure. As shown, the login screen includes a username and password. A successful login allows users to modify their Use Settings as detailed above.

In some embodiments, a computer program including instructions which, when executed by at least one processor (e.g., processor 26), cause the at least one processor to carry out the functionality of any of the components of payment system 10 according to any one of the embodiments described herein as provided. In some embodiments, a carrier containing the aforementioned computer program product is provided. The carrier is one of an electronic signal, an optical signal, a radio signal, or a computer readable storage medium (e.g., a non-transitory computer readable medium such as the memory 28).

In addition to the above mentioned embodiments, various other modifications and alterations of the invention may be made without departing from the invention. For example, embodiments of the payment system 10 may utilize a non-encrypted network and non-cryptocurrencies. As such, any payment system that provides small- or micro-payments to multiple recipients could be utilized. In some embodiments, additional features of the payment system 10 may include accounting and reporting services about how content is accessed, distributed, and the like. As such, small or micro-payments to numerous parties from a single transaction can be recorded for auditing purposes and report generation. Accordingly, the above disclosure is not to be considered as limiting and the appended embodiments are to be interpreted as encompassing the spirit and the scope of the invention.

1. A payment system comprising a payment server computer operable to utilize encrypted computer networking to process payments, the payment server computer comprising:
one or more processors; and
memory containing instructions executable by the one or more processors whereby the payment server computer is operable to:
store a plurality of accounts;
process a payment between the plurality of accounts by utilizing the encrypted computer networking.

2. The payment system of embodiment 1 wherein the payment server computer splits the payment into predetermined percentages for a subset of the plurality of accounts.

3. The payment system of embodiment 1 wherein the payment server computer automatically provides fractions or subdivisions of the payment to relevant parties having respective accounts in the plurality of accounts.

4. The payment system of embodiment 3 wherein the payment server computer of the payment system automatically converts the fractions or subdivisions of the payment into a plurality of currencies.

5. The payment system of embodiment 1 wherein the plurality of accounts comprise user accounts and content provider accounts.

6. The payment system of embodiment 5 wherein each of the plurality of accounts comprises a private key and a public key for utilizing the encrypted computer networking to process payments.

7. The payment system of embodiment 6 wherein the payment server computer is further operable to distribute portions of the payment from a user account to one or more content provider accounts by utilizing a private key of the user account and respective public keys of the one or more content provider accounts.

8. The payment system of embodiment 7 wherein the portions of the payment and the one or more content provider accounts are determined in accordance with a clicking operation such that the user account obtains a single use license to view clicked content.

9. The payment system of embodiment 7 wherein the portions of the payment and the one or more content provider accounts are determined in accordance with one of a plurality of options selected for the user account to obtain a license to content.

10. The payment system of embodiment 9 wherein the plurality of options comprise play, purchase, rent, share content, and tip.

11. The payment system of embodiment 10 wherein the portions of the payment and the one or more content provider accounts are determined in accordance with selection of the play option such that the user account obtains a single use license to view selected content.

12. The payment system of embodiment 10 wherein the portions of the payment and the one or more content provider accounts are determined in accordance with selection of the purchase option such that the user account obtains a license to own selected content.

13. The payment system of embodiment 10 wherein the portions of the payment and the one or more content provider accounts are determined in accordance with selection of the rent option such that the user account obtains a license to rent selected content.

14. The payment system of embodiment 10 wherein the portions of the payment and the one or more content provider accounts are determined in accordance with selection of the share content option such that selected content is shared on a website, email, or blog.

15. The payment system of embodiment 10 wherein the tip option designates the payment to a content provider account irrespective of whether the user account obtains a license to selected content.

16. The payment system of embodiment 1 wherein the encrypted computer networking comprises the Blockchain.

17. A method performed by a server computer operable to utilize encrypted computer networking to process a payment, comprising:
receiving a request to make a payment for a user seeking to access content, or purchase a product or service; and
distributing portions of the payment from a user account into one or more content provider accounts by utilizing encrypted computer networking.

18. The method of embodiment 17 wherein the portions of the payment and the one or more content provider accounts are determined in accordance with a selection of one or more rights to access the content.

19. The method of embodiment 17 wherein the distributing of the portions of the payment comprises utilizing a private key of the user account and respective public keys for the one or more content providers.

20. The payment system of embodiment 17 wherein the encrypted computer networking comprises the Blockchain.
